(19) United States
(12) Patent Application Publication
(10) Pub. No.: US 2009/0123730 A1
(43) Pub. Date: May 14, 2009

(54) SURFACE TO BE SOLDERED

(75) Inventors: Snjezana Boger Boger, Esslingen (DE); Peter Englert, Bad Friedrichshall (DE); Dieter Gross, Stuttgart (DE); Matthias Pfitzer, Deizisau (DE); Ingo Trautwein, Bietigheim-Bissingen (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/996,712

(22) PCT Filed: Jul. 21, 2006
(86) PCT No.: PCT/EP06/07190

§ 371 Date: May 19, 2008

(30) Foreign Application Priority Data
Jul. 27, 2005 (DE) 10 2005 035 704.0

(51) Int. Cl. B32B 15/04; B32B 9/04; B23K 1/00; B23K 31/02; B32B 5/16

(52) U.S. Cl. 428/323; 428/446; 428/698; 428/702; 428/469; 228/101; 228/219; 228/221

(57) ABSTRACT

The invention relates to a surface of an object, especially a heat exchanger, e.g. a lateral part, a wavy rib, or a tube of a heat exchanger, which is to be soldered by means of a flux layer (2). In order to improve the properties of the surface that is to be soldered, said surface is provided with at least one more layer (3; 13, 16) in addition to the flux layer (2). The at least one more layer (3; 13; 16) contains an additive which modifies the surface to be soldered, said additive being reacted in order to modify the surface when the surface that is to be soldered is soldered.

The invention relates to a solderable surface of an object, in particular of a heat exchanger, for example a side part, a corrugated fin or a tube of a heat exchanger, having a layer of flux.

German laid-open specification DE 101 41 883 A1 has disclosed a process in which a layer of flux and a sealing layer are applied to a blank part. German laid-open specification DE 102 10 133 A1 has disclosed a flux for the soldering of aluminum, to which zirconium fluoride and/or titanium fluoride has been added. European patent application EP 1 142 663 A1 and U.S. Pat. No. 3,945,899 have disclosed the application of boehmite layers to aluminum surfaces. U.S. Pat. No. 5,518,555 has disclosed a surface treatment process based on an aqueous zirconium polyacrylamide solution and the corresponding metal fluorides. U.S. Pat. No. 5,584,946 has disclosed a pretreatment and surface treatment process based on complex fluorides of the elements boron, zirconium, hafnium and titanium. U.S. Pat. No. 5,692,145 has disclosed a surface treatment process based on complex fluorides of the elements boron, zirconium, hafnium, titanium, silicon, germanium, tin, in conjunction with polymers. U.S. Pat. No. 5,795,659 has disclosed an aluminum surface comprising the metals zirconium, hafnium, rhenium, manganese, titanium and comprising silicates and borates to protect against corrosion and to protect against high-temperature corrosion. International patent application WO 00/73014 A1 has disclosed the application of an aluminum/silicon compound. With the addition of fluoridic fluxes, an aluminum/silicon solder is to be formed on heating of the component. German laid-open specification DE 43 38 361 A1 has disclosed a process for producing compositions based on epoxy-containing silanes. German utility model DE 200 18 520 U1 has disclosed a filter-free heat exchanger using nanotechnology. A process for producing a hydrophilic surface of a heat exchanger is known from European patent application EP 1 154 042 A1. A process for producing fine-particle metal and ceramic powders is known from German laid-open specification DE 42 14 719 A1. A process for producing nano-crystalline powders from metals, alloys and/or ceramic materials is known from German laid-open specification DE 39 37 740 A1. Fine-particle metal, alloy and metal compound powders are known from German patent DE 43 37 336 C1.

Certain surface properties are required for the functionality and efficiency of heat exchangers. These include properties such as resistance to corrosion, hydrophilicity/water run-off, dirt repellency, biocidal and/or biostatic or repellant action to microorganisms, odor reduction, etc., coatings, for example painted coatings or conversion treatments, for example chromating, can only be carried out on the finished component after soldering. Corresponding costs and a high consumption of resources for operation of the additional treatment facilities, for example chromating installations, dip-coating installations and spin-coating installations for the application of paint, as well as the outlay on logistics and handling of the materials, are correspondingly high.

It is an object of the invention to provide a solderable surface of an object, in particular of a heat exchanger, for example a side part, a corrugated fin or a tube of a heat exchanger, having a layer of flux, which in the soldered state has at least one additional property, such as protection against corrosion, hydrophilicity/water run-off, dirt repellency, biocidal and/or biostatic or repellant action to microorganisms, odor reduction, etc., and can be produced at low cost.

For a solderable surface of an object, in particular of a heat exchanger, for example a side part, a corrugated fin or a tube of a heat exchanger, having a layer of flux, the object is achieved by virtue of the fact that the solderable surface, in addition to the layer of flux, has at least one further layer which contains an addition that modifies the solderable surface and is reacted during soldering of the surface that is to be soldered in order to modify the surface. In the context of the present invention, it has emerged that the addition of modifying additions to the layer of flux does not always give particularly satisfactory results. For example, the resistance to corrosion can be improved by the modifying addition. The type and arrangement of the further layers are variable and customer-specific. The modification of the surface advantageously takes place during the soldering process. The surface according to the invention can be better matched to desired surface requirements than conventional finished products. The application of one or preferably more further layers allows the desired surface effects to be deliberately controlled and adjusted. The layer of flux preferably comprises an inexpensive standard flux without additions.

The object indicated above is also achieved, for a solderable surface of an object, in particular of a heat exchanger, for example a side part, a corrugated fin or a tube of a heat exchanger, having a layer of flux, by virtue of the fact that the layer of flux as binder contains at least one organometal compound which is reacted during the soldering of the solderable surface in order to modify the surface. The use of organometal compounds as binder has the advantage that the binder can simultaneously be used to modify the solderable surface during soldering.

A preferred exemplary embodiment of the surface is characterized in that the layer of flux contains elemental silicon or silicon compounds. During the soldering process, the silicon can diffuse into the base material of the solderable surface and form the solder.

Another preferred exemplary embodiment of the surface is characterized in that the solderable surface has a layer of solder. The solderable surface may, for example, be plated with solder.

Another preferred exemplary embodiment of the surface is characterized in that the at least one further layer contains elemental silicon or silicon compounds. During the soldering process, the silicon diffuses out of the further layer into the base material of the solderable surface and forms the solder.

Further preferred exemplary embodiments of the surface are characterized in that the at least one further layer is arranged above and/or below the layer of flux. The number and arrangement of the layers can be adapted to the desired properties as a function of the compounds contained in the layers.

Another preferred exemplary embodiment of the surface is characterized in that the at least one further layer contains silicone resins. It is preferable for the further layer to contain additives in addition to the silicone resins.

Another preferred exemplary embodiment of the surface is characterized in that the at least one further layer contains metal salts. These are preferably salts of the transition metal/main group elements of the Periodic System of the Elements.

Further preferred exemplary embodiments of the surface are characterized in that the at least one further layer contains metal salts of the elements of transition groups III-VI and/or metal salts of the elements of main group II of the Periodic System of the Elements.

Another preferred exemplary embodiment of the surface is characterized in that the at least one further layer contains organometal compounds. The organometal compounds are reacted during the soldering of the solderable surface in order to modify the surface.

Another preferred exemplary embodiment of the surface is characterized in that the at least one further layer contains organometal compounds based on titanium, zirconium and/or silicon. These are, for example, tetra-n-propoxysilane, zirconium n-propoxide and titanium n-propoxide.

Another preferred exemplary embodiment of the surface is characterized in that the at least one further layer contains nanoparticles. It is preferable for the nano-particles to be in dispersion.

A further preferred exemplary embodiment of the surface is characterized in that the nanoparticles comprise oxides, oxide hydrates, nitrides and/or carbides. During the soldering process, it is preferable for metal nano-compounds to be partially reduced and converted into metals.

Another preferred exemplary embodiment of the surface is characterized in that the nanoparticles comprise oxides, oxide hydrates, nitrides and/or carbides of main group elements of the Periodic System of the Elements, such as for example aluminum, silicon, indium, boron and/or transition metals preferably from transition group IV and V and/or cerium and/or zinc and/or metallic nanoparticles, for example composed of silicon, aluminum, zirconium, titanium, and/or coated nanoparticles and/or grafted nanoparticles of the abovementioned substances or compounds.

Another preferred exemplary embodiment of the surface is characterized in that the nanoparticles have a size of between 1 and 1000 nm. This size has proven particularly advantageous within the context of the present invention.

Another preferred exemplary embodiment of the surface is characterized in that the at least one further layer contains sol. A sol is a substance which is colloidally dispersed in a dispersant and the particles of which can move freely.

Another preferred exemplary embodiment of the surface is characterized in that the sol or sols contain(s) nanoparticles and/or metal salts. The nanoparticles and metal salts are preferably the nanoparticles and metal salts described above.

Another preferred exemplary embodiment of the surface is characterized in that the solderable surface as base material contains aluminum or aluminum alloys. To solder aluminum and aluminum alloys, it is necessary for an aluminum oxide layer that forms to be at least partially removed prior to soldering. By way of example, a flux is used for this purpose.

The invention also relates to an object, in particular a heat exchanger, for example a side part, a corrugated fin or a tube of a heat exchanger, having a solderable surface as described above. Depending on the particular requirements, different parts may have different surfaces with differently formed and/or arranged further layers.

The invention also relates to an object, in particular a heat exchanger, for example a side part, a corrugated fin or a tube of a heat exchanger, having a soldered surface as described above. During the soldering of the solderable surface, the modifying addition of the further layer was reacted.

A preferred exemplary embodiment of the object is characterized in that the soldered surface contains a semi-ceramic oxide layer. The semi-ceramic oxide layer in turn comprises, for example, silicon dioxide, zirconium dioxide or titanium dioxide (passive protection against corrosion) and/or mixed compounds with the flux and/or nitrides during the soldering under a shielding gas atmosphere.

Another preferred exemplary embodiment of the object is characterized in that the soldered surface has a cathodically acting surface layer. This ensures cathodic protection of the surface.

The invention also relates to a process for producing an object as described above, which is characterized in that the at least one further layer comprising the modifying addition is reacted during the soldering process. The surface according to the invention, the object according to the invention and the process according to the invention provide inter alia the following advantages: reduced production costs for heat exchangers as a result of saving on aftertreatment and logistical costs; energy saving and preservation of resources as a result of a single-stage manufacturing process; avoidance of the use of aggressive chemicals for the surface treatment and elimination of the wastewater treatment; the range of chemicals that can be used is wider if the chemicals no longer have to be added to the solder/flux suspension in dissolved or dispersed state and therefore can no longer react with the flux; saving on the solder plating in the case of aluminum materials; and the use of a plurality of layers allows standard aluminum materials to be used as base material for the solderable surface.

A preferred exemplary embodiment of the process is characterized in that the reaction of the at least one further layer comprising the modifying addition takes place at temperatures up to 620 degrees Celsius. This temperature limit has proven particularly advantageous within the context of the present invention.

Further preferred exemplary embodiments of the process are characterized in that the reaction of the at least one further layer comprising the modifying addition takes place under a shielding gas atmosphere, at atmospheric pressure or at pressures below atmospheric pressure.

Another preferred exemplary embodiment of the process is characterized in that the compounds contained in the at least one further layer are reacted during the soldering process to form semi-ceramic oxide layers. This reaction has proven particularly advantageous in the context of the present invention.

Further advantages, features and details of the invention will emerge from the following description, in which various exemplary embodiments are described in detail with reference to the drawing. The features mentioned in the claims and the description may in each case be pertinent to the invention both individually and in any suitable combination. In the drawing:

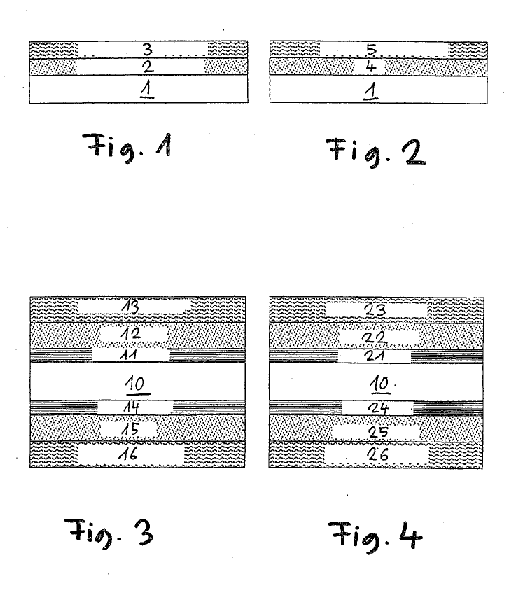

FIG. 1 shows an object which has been coated on one side prior to soldering, in section;

FIG. 2 shows the object from FIG. 1 after soldering, in section;

FIG. 3 shows an object which has been coated on both sides prior to soldering, in section; and

FIG. 4 shows the object from FIG. 3 after soldering, in section.

The conventional processes for protecting against corrosion, such as chromating, are carried out on the finished heat exchanger after the actual soldering operation. To solder aluminum and/or aluminum alloys, it is necessary for the aluminum oxide layer to be at least partially removed prior to soldering. This is generally done using fluxes. According to the present invention, at least one further layer, preferably a plurality of further layers, are applied above or below a layer of flux.

The core concept of the invention is based on reacting the layers applied above or below the layer of flux during the soldering process at temperatures of up to 620 degrees Celsius under a shielding gas atmosphere and/or at atmospheric pressure or pressures below atmospheric pressure. Depending on the composition of the aluminum base material, the layer of flux may contain elemental silicon or silicon compounds.

An aluminum surface which has been coated in accordance with the present invention has the following properties: formation of dense, corrosion-resistant surface layers during the cooling process; controlled setting of hydrophilic properties; production of odor-reducing layers; protection against corrosion as a result of the controlled setting of the corrosion potentials between the individual layers and/or the coating and the base material and/or between the individual heat exchanger components, for example plate/corrugated fin, via the production of diffusion layers.

The aluminum base material/aluminum alloy can be used in the following form: use of solder-plated semi-finished products; use of semi-finished products without solder plating, in which case the solder is formed from elemental silicon during the soldering process; the elemental silicon is contained in one of the applied layers; at high temperatures the silicon diffuses into the base material and forms the solder; use of semi-finished products without solder plating, in which case the solder is formed during the soldering process through reduction of a silicon-containing compound on the aluminum/aluminum alloy surface; the silicon-containing compound is contained in one of the applied layers; at high temperatures the silicon formed through reduction diffuses into the base material and forms the solder.

Since the coating according to the invention can be implemented on the air and/or coolant/refrigerant side of a heat exchanger, the process according to the invention allows protection against corrosion to be achieved on the air and coolant/refrigerant side.

It is preferable for the layer of flux to be applied by spraying individual heat exchanger components with flux dispersions. Another way of applying the flux is coil coating, in which the flux is applied to the aluminum strip material before it is processed further to form heat exchanger components.

The application of the further layers to substrates consisting of solder-plated and/or unplated aluminum and/or aluminum alloys can be integrated into the existing process by the addition of further application devices. If necessary, the layer that has already been applied can be dried prior to the next application step.

In the case of the application of flux dispersions to heat exchanger components and/or in the case of the coil coating process, further coating devices are integrated into the existing process. The application of the flux and of the additional layers can be effected using all available processes, such as for example spraying, rolling-on, dip-coating, doctor-coating, evaporation coating.

FIG. 1 illustrates a section through a part of a heat exchanger. The heat exchanger part is formed from a base material 1. The base material 1 is aluminum. The base material 1 is coated on one side with a flux 2 that includes silicon particles. A further layer 3 which comprises organometal compounds is applied to the layer of flux 2. The heat exchanger part shown in FIG. 1 is exposed to temperatures of up to over 600 degrees Celsius during soldering.

FIG. 2 shows the state after soldering. During soldering, the layer of flux (2 in FIG. 1) was reacted to form a layer of solder 4. The further layer (3 in FIG. 1) during soldering was reacted to form a further layer 5 which contains a mixed compound with flux.

FIG. 3 illustrates, in section, a heat exchanger part that has been coated on both sides. The heat exchanger part comprises a base material 10 of an aluminum alloy. Three layers 11, 12, 13 have been applied to the top side of the base material 10. The layer 11 is a solder plating. The layer 12 comprises flux. The layer 13 comprises a sol containing zirconium dioxide nano-particles. Three layers 14, 15, 16, which correspond to the layers 11, 12, 13, have been applied to the underside of the base material 10. FIG. 3 illustrates the state prior to soldering.

FIG. 4 illustrates the state after soldering. The layers (11 and 14 in FIG. 3) with the solder plating, during soldering, were reacted to form layers of solder 21, 24. The layers of flux (12 and 15 in FIG. 3) were reacted during soldering to form flux phase layers 22, 25. The sol layers (13 and 16 in FIG. 3) during soldering were reacted to form semi-ceramic phase layers 23 and 26.

1. A solderable surface of a heat exchanger comprising a layer of flux, wherein the solderable surface, in addition to the layer of flux, has at least one further layer which contains an addition that modifies the solderable surface and is reacted during soldering of the surface that is to be soldered in order to modify the surface.

2. A solderable surface of a heat exchanger comprising a layer of flux, as claimed in claim 1, wherein the layer of flux as binder contains at least one organometal compound which is reacted during the soldering of the solderable surface in order to modify the surface.

3. The solderable surface as claimed in claim 1, wherein the layer of flux contains elemental silicon or silicon compounds.

4. The solderable surface as claimed in claim 1, wherein the solderable surface has a layer of solder.

5. The solderable surface as claimed in claim 1, wherein at least one further layer contains elemental silicon or silicon compounds.

6. The solderable surface as claimed in claim 1, wherein at least one further layer is arranged above the layer of flux.

7. The solderable surface as claimed in claim 1, wherein at least one further layer is arranged below the layer of flux.

8. The solderable surface as claimed in claim 1, wherein at least one further layer contains silicone resins.

9. The solderable surface as claimed in claim 1, wherein at least one further layer contains metal salts.

10. The solderable surface as claimed in claim 9, wherein at least one further layer contains metal salts of the elements from transition groups III-VI of the Periodic System.

11. The solderable surface as claimed in claim 9, wherein at least one further layer contains metal salts of the elements from main group II of the Periodic System of the Elements.

12. The solderable surface as claimed in claim 1, wherein at least one further layer contains organometal compounds.

13. The solderable surface as claimed in claim 12, wherein at least one further layer contains organometal compounds based on titanium/zirconium and/or silicon.

14. The solderable surface as claimed in claim 1, wherein at least one further layer contains nanoparticles.

15. The solderable surface as claimed in claim 14, wherein the nanoparticles comprise oxides, oxide hydrates, nitrides and/or carbides.

16. The solderable surface as claimed in claim 15, wherein the nanoparticles comprise oxides, oxide hydrates, nitrides and/or carbides of main group elements of the Periodic System of the Elements, such as for example aluminum, silicon, indium, boron and/or transition metals preferably from transition group IV and V and/or cerium and/or zinc and/or metallic nanoparticles, for example composed of silicon, aluminum, zirconium, titanium, and/or coated nanoparticles and/or grafted nanoparticles of the abovementioned substances or compounds.

17. The solderable surface as claimed in claim 14, wherein the nanoparticles have a size of between 1 and 1000 nm.

18. The solderable surface as claimed in claim 1, wherein at least one further layer contains sol.

19. The solderable surface as claimed in claim 18, wherein the sol or sols contain(s) nanoparticles and/or metal salts.

20. The solderable surface as claimed in claim 1, wherein the solderable surface as base material contains aluminum or at least one aluminum alloy.

21. An object, in particular a heat exchanger, for example a side part, corrugated fin or tube of a heat exchanger, having a solderable surface as claimed in one of the preceding claims.

22. An object, in particular a heat exchanger, for example a side part, corrugated fin or tube of a heat exchanger, having a soldered surface as claimed in claim 1.

23. The object as claimed in claim 22, wherein the soldered surface contains a semi-ceramic oxide layer.

24. The object as claimed in claim 22, wherein the soldered surface has a cathodically acting surface layer.

25. A process for producing the object as claimed in claim 22, wherein at least one further layer comprising the modifying addition is reacted during the soldering process.

26. The process as claimed in claim 25, wherein the reaction of the at least one further layer comprising the modifying addition takes place at temperatures up to 620 degrees Celsius.

27. The process as claimed in claim 25, wherein the reaction of the at least one further layer comprising the modifying addition takes place in a shielding gas atmosphere.

28. The process as claimed in claim 25, wherein the reaction of the at least one further layer comprising the modifying addition takes place at atmospheric pressure.

29. The process as claimed in claim 25, wherein the reaction of the at least one further layer comprising the modifying addition takes place at pressures below atmospheric pressure.

30. The process as claimed in claim 25, wherein the compounds contained in the at least one further layer are reacted during the soldering process to form semi-ceramic oxide layers.
